(19) United States
(12) Patent Application Publication
(10) Pub. No.: US 2024/0014885 A1
(43) Pub. Date: Jan. 11, 2024

(54) CONTROL INFORMATION TRANSMISSION IN RELAY-BASED COMMUNICATION FOR REDUCED CAPACITY USER EQUIPMENT

(71) Applicant: QUALCOMM Incorporated, San Diego, CA (US)

(72) Inventors: Luanxia YANG, Beijing (CN); Changlong XU, Beijing (CN); Jing SUN, San Diego, CA (US); Xiaoxia ZHANG, San Diego, CA (US); Hao XU, Beijing (CN)

(21) Appl. No.: 18/253,294

(22) PCT Filed: Jan. 22, 2021
(86) PCT No.: PCT/CN2021/073175

§ 371 Date: May 17, 2023

(51) Int. Cl. H04B 7/155; H04W 72/20

(52) U.S. Cl. CPC H04B 7/15528; H04W 72/20

(57) ABSTRACT

Various aspects of the present disclosure generally relate to wireless communication. In some aspects, a relay device may receive, from a base station, a data message that includes at least first control information associated with a first user equipment (UE) and second control information associated with a second UE. The relay device may transmit, to the first UE, the first control information based at least in part on information included in a header associated with the data message. The relay device may transmit, to the second UE, the second control information based at least in part on the information included in the header. Numerous other aspects are described.

### FIELD OF THE DISCLOSURE

Aspects of the present disclosure generally relate to wireless communication and to techniques and apparatuses for control information transmission in relay-based communication for reduced capacity user equipment.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a relay device for wireless communication includes a memory and one or more processors operatively coupled to the memory, the memory and the one or more processors configured to receive, from a base station, a data message that includes at least first control information associated with a first user equipment (UE) and second control information associated with a second UE; transmit, to the first UE, the first control information based at least in part on information included in a header associated with the data message; and transmit, to the second UE, the second control information based at least in part on the information included in the header.

In some aspects, a base station for wireless communication includes a memory and one or more processors operatively coupled to the memory, the memory and the one or more processors configured to aggregate, into a data message, at least first control information associated with a first UE and second control information associated with a second UE; and transmit, to a relay device, the data message that includes at least the first control information and the second control information.

In some aspects, a relay device for wireless communication includes a memory and one or more processors operatively coupled to the memory, the memory and the one or more processors configured to receive, from a first UE, first control information; receive, from a second UE, second control information; aggregate the first control information and the second control information into a data message that includes at least the first control information and the second control information; and transmit, to a base station, the data message that includes at least the first control information and the second control information.

In some aspects, a relay device for wireless communication includes a memory and one or more processors operatively coupled to the memory, the memory and the one or more processors configured to receive, from a base station, a data message that includes at least first data associated with a first UE and second data associated with a second UE; transmit, to the first UE, the first data based at least in part on information included in a header associated with the data message; and transmit, to the second UE, the second data based at least in part on the information included in the header.

In some aspects, a method of wireless communication performed by a relay device includes receiving, from a base station, a data message that includes at least first control information associated with a first UE and second control information associated with a second UE; transmitting, to the first UE, the first control information based at least in part on information included in a header associated with the data message; and transmitting, to the second UE, the second control information based at least in part on the information included in the header.

In some aspects, a method of wireless communication performed by a base station includes aggregating, into a data message, at least first control information associated with a first UE and second control information associated with a second UE; and transmitting, to a relay device, the data message that includes at least the first control information and the second control information.

In some aspects, a method of wireless communication performed by a relay device includes receiving, from a first UE, first control information; receiving, from a second UE, second control information; aggregating the first control information and the second control information into a data message that includes at least the first control information and the second control information; and transmitting, to a base station, the data message that includes at least the first control information and the second control information.

In some aspects, a method of wireless communication performed by a relay device includes receiving, from a base station, a data message that includes at least first data associated with a first UE and second data associated with a second UE; transmitting, to the first UE, the first data based at least in part on information included in a header associated with the data message; and transmitting, to the second UE, the second data based at least in part on the information included in the header.

In some aspects, a non-transitory computer-readable medium storing a set of instructions for wireless communication includes one or more instructions that, when executed by one or more processors of a relay device, cause the relay device to receive, from a base station, a data message that includes at least first control information associated with a first UE and second control information associated with a second UE; transmit, to the first UE, the first control information based at least in part on information included in a header associated with the data message; and transmit, to the second UE, the second control information based at least in part on the information included in the header.

In some aspects, a non-transitory computer-readable medium storing a set of instructions for wireless communication includes one or more instructions that, when executed by one or more processors of a base station, cause the base station to aggregate, into a data message, at least first control information associated with a first UE and second control information associated with a second UE; and transmit, to a relay device, the data message that includes at least the first control information and the second control information.

In some aspects, a non-transitory computer-readable medium storing a set of instructions for wireless communication includes one or more instructions that, when executed by one or more processors of a relay device, cause the relay device to receive, from a first UE, first control information; receive, from a second UE, second control information; aggregate the first control information and the second control information into a data message that includes at least the first control information and the second control information; and transmit, to a base station, the data message that includes at least the first control information and the second control information.

In some aspects, a non-transitory computer-readable medium storing a set of instructions for wireless communication includes one or more instructions that, when executed by one or more processors of a relay device, cause the relay device to receive, from a base station, a data message that includes at least first data associated with a first UE and second data associated with a second UE; transmit, to the first UE, the first data based at least in part on information included in a header associated with the data message; and transmit, to the second UE, the second data based at least in part on the information included in the header.

In some aspects, an apparatus for wireless communication includes means for receiving, from a base station, a data message that includes at least first control information associated with a first UE and second control information associated with a second UE; means for transmitting, to the first UE, the first control information based at least in part on information included in a header associated with the data message; and means for transmitting, to the second UE, the second control information based at least in part on the information included in the header.

In some aspects, an apparatus for wireless communication includes means for aggregating, into a data message, at least first control information associated with a first UE and second control information associated with a second UE; and means for transmitting, to a relay device, the data message that includes at least the first control information and the second control information.

In some aspects, an apparatus for wireless communication includes means for receiving, from a first UE, first control information; means for receiving, from a second UE, second control information; means for aggregating the first control information and the second control information into a data message that includes at least the first control information and the second control information; and means for transmitting, to a base station, the data message that includes at least the first control information and the second control information.

In some aspects, an apparatus for wireless communication includes means for receiving, from a base station, a data message that includes at least first data associated with a first UE and second data associated with a second UE; means for transmitting, to the first UE, the first data based at least in part on information included in a header associated with the data message; and means for transmitting, to the second UE, the second data based at least in part on the information included in the header.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a multi-user packet (MUP), in accordance with the present disclosure.

FIGS. 4, 5, and 6 are diagrams illustrating examples associated with transmitting downlink control information in relay-based communication for reduced capacity UEs (RedCap UEs), in accordance with the present disclosure.

FIGS. 7, 8A, 8B, and 9 are diagrams illustrating examples associated with transmitting uplink control information in relay-based communication for RedCap UEs, in accordance with the present disclosure.

FIGS. 10, 11, 12, and 13 are diagrams illustrating example processes associated with control information transmission in relay-based communication for RedCap UEs, in accordance with the present disclosure.

FIGS. 14 and 15 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

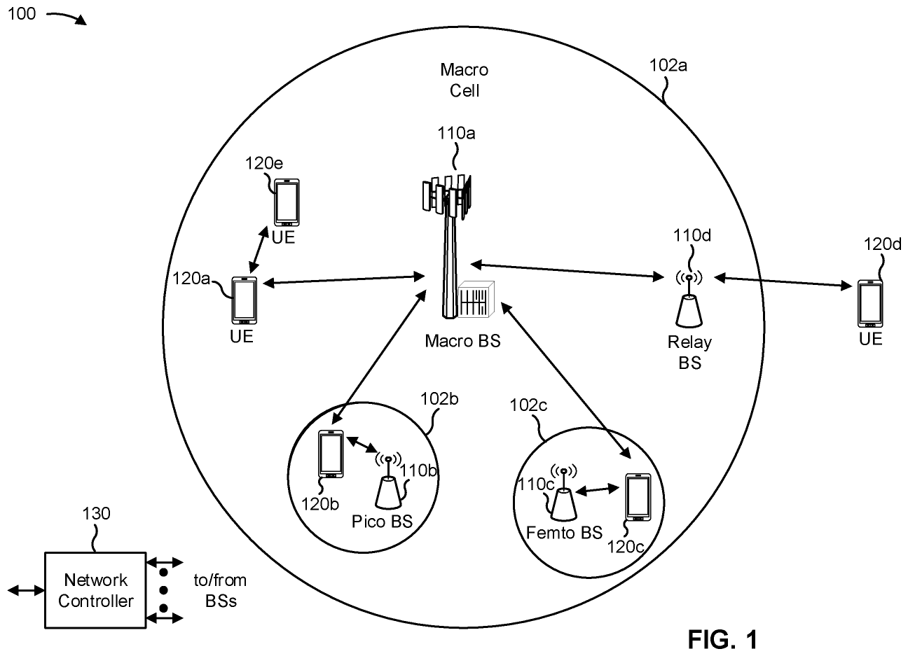

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”. “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

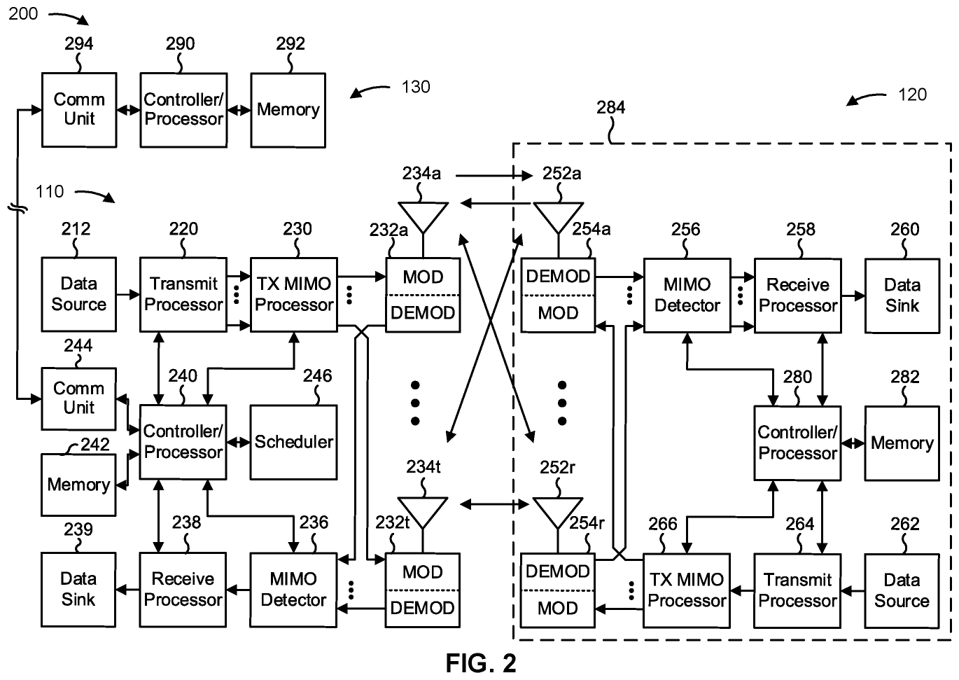

FIG. 2 is a diagram illustrating an example 200 of abase station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a channel quality indicator (CQI) parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

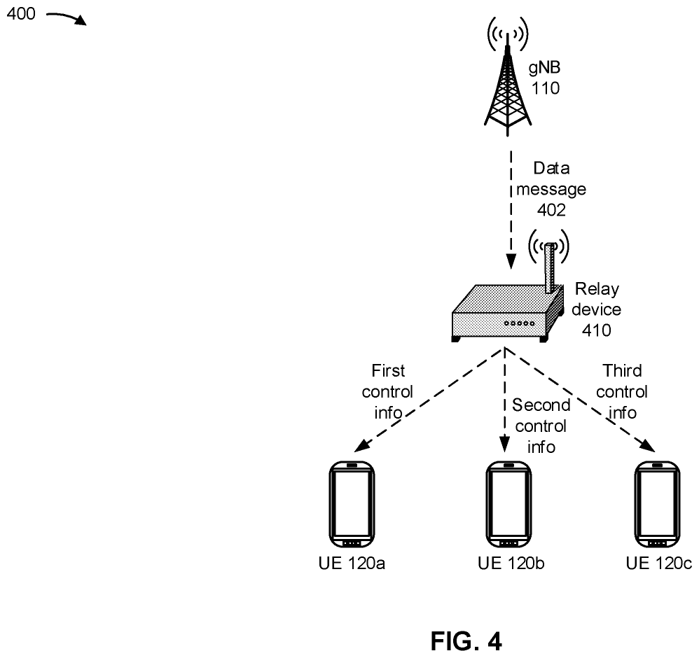

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM) and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 4-9.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 4-9.

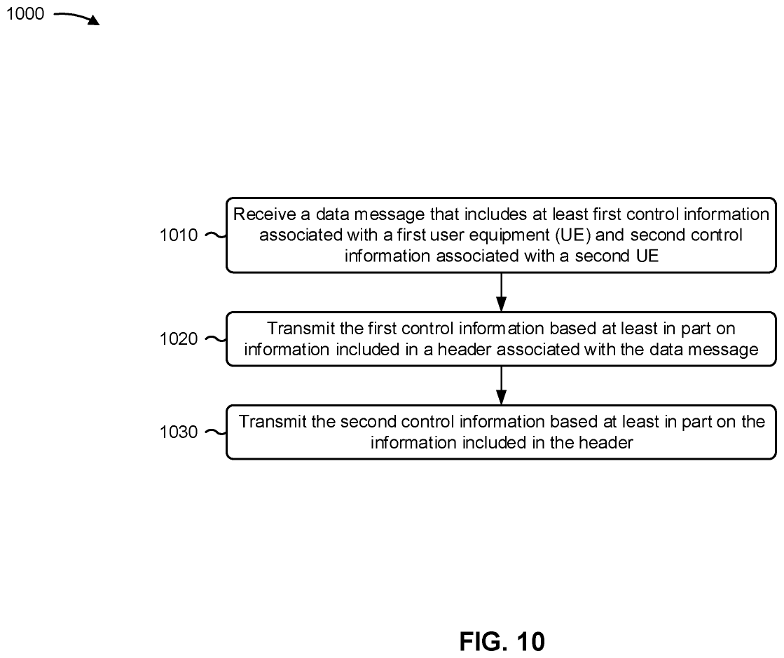

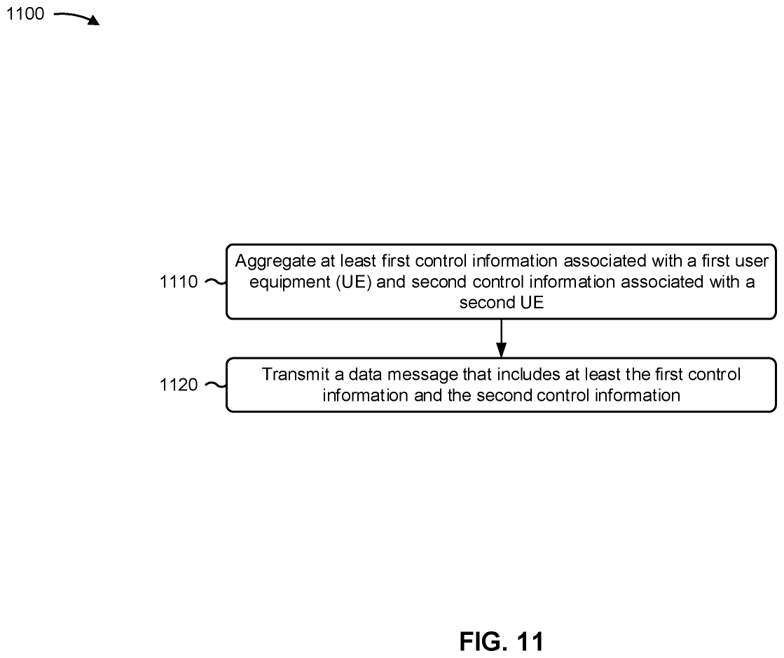

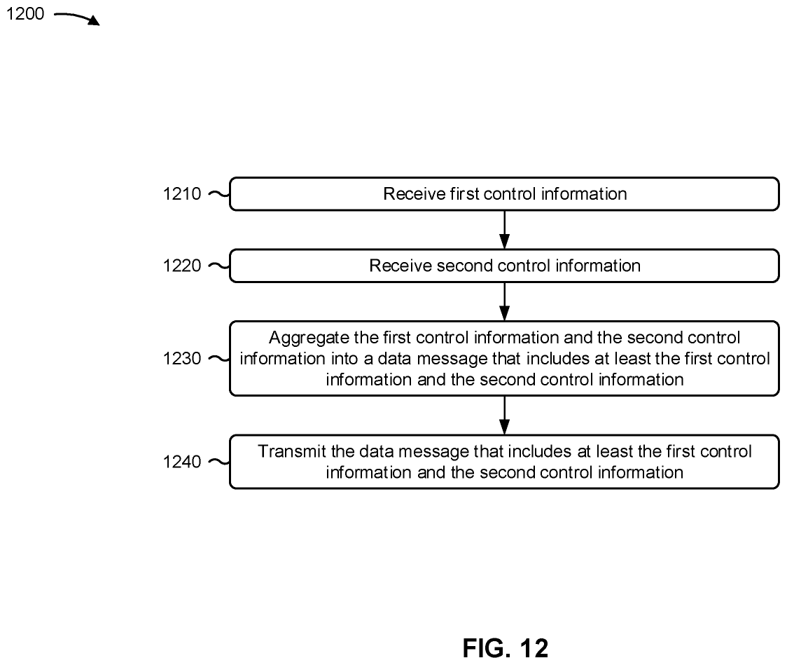

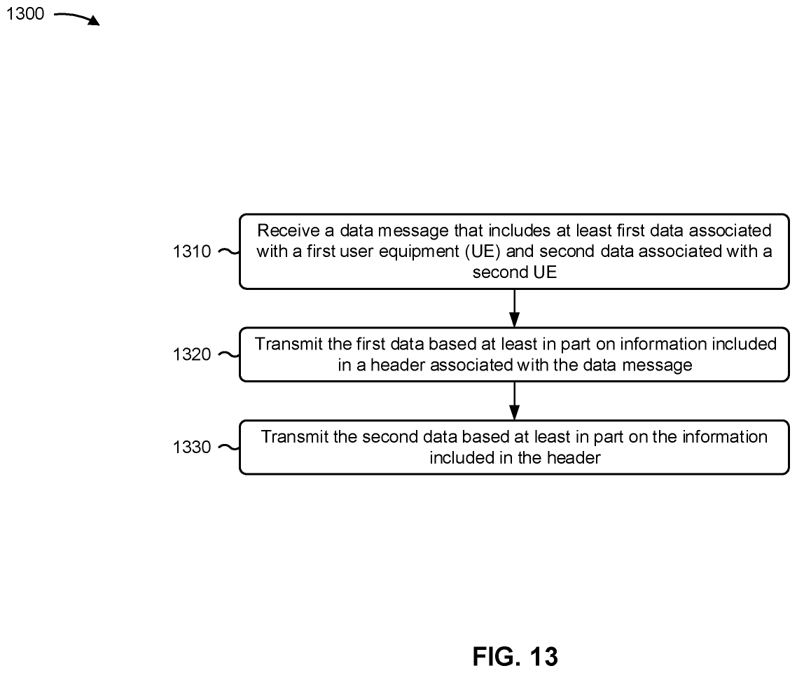

Controller/processor 240 of base station 110, controller/processor 280 of UE 120, and/or any other component(s) of FIG. 2 may perform one or more techniques associated with control information transmission in relay-based communication for RedCap UEs, as described in more detail elsewhere herein. For example, controller/processor 240 of base station 110, controller/processor 280 of UE 120, and/or any other component(s) of FIG. 2 may perform or direct operations of, for example, process 1000 of FIG. 10, process 1100 of FIG. 11, process 1200 of FIG. 12, process 1300 of FIG. 13, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1000 of FIG. 10, process 1100 of FIG. 11, process 1200 of FIG. 12, process 1300 of FIG. 13, and/or other processes as described herein. In some aspects, executing instructions may include running the instructions, converting the instructions, compiling the instructions, and/or interpreting the instructions, among other examples. In some aspects, the relay device described herein is the UE 120, is included in the UE 120, or includes one or more components of the UE 120 shown in FIG. 2.

In some aspects, the relay device may include means for receiving, from a base station, a data message that includes at least first control information associated with a first UE and second control information associated with a second UE; means for transmitting, to the first UE, the first control information based at least in part on information included in a header associated with the data message; and/or means for transmitting, to the second UE, the second control information based at least in part on the information included in the header. In some aspects, the means for the relay device to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the relay device may further include means for receiving, from the base station, control information associated with the relay device. Additionally, or alternatively, the relay device may include means for attempting to decode a previous data message that includes control information associated with a plurality of UEs,

In some aspects, abase station (e.g., the base station 110) may include means for aggregating, into a data message, at least first control information associated with a first UE and second control information associated with a second UE; and/or means for transmitting, to a relay device, the data message that includes at least the first control information and the second control information. The means for the base station to perform operations described herein may include, for example, one or more of transmit processor 220, TX MIMO processor 230, modulator 232, antenna 234, demodulator 232. MIMO detector 236, receive processor 238, controller/processor 240, memory 242, or scheduler 246.

In some aspects, the base station may further include means for transmitting, to the relay device, control information associated with the relay device. Additionally. or alternatively, the base station includes means for receiving, from the relay device, a negative-acknowledgment (NACK) signal associated with a previous data message that includes control information associated with a plurality of UEs,

In some aspects, the relay device may include means for receiving, from a first UE, first control information; means for receiving, from a second UE, second control information; means for aggregating the first control information and the second control information into a data message that includes at least the first control information and the second control information; and/or means for transmitting, to a base station, the data message that includes at least the first control information and the second control information. In some aspects, the means for the relay device to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the relay device may further include means for receiving, from the base station, a NACK signal, and/or means for retransmitting the data message to the base station based at least in part on receiving the NACK signal.

In some aspects, the relay device may include means for receiving, from a base station, a data message that includes at least first data associated with a first UE and second data associated with a second UE; means for transmitting, to the first UE, the first data based at least in part on information included in a header associated with the data message; or means for transmitting, to the second UE, the second data based at least in part on the information included in the header. In some aspects, the means for the relay device to perform operations described herein may include, for example, one or more of antenna 252, demodulator 254, MIMO detector 256, receive processor 258, transmit processor 264, TX MIMO processor 266, modulator 254, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

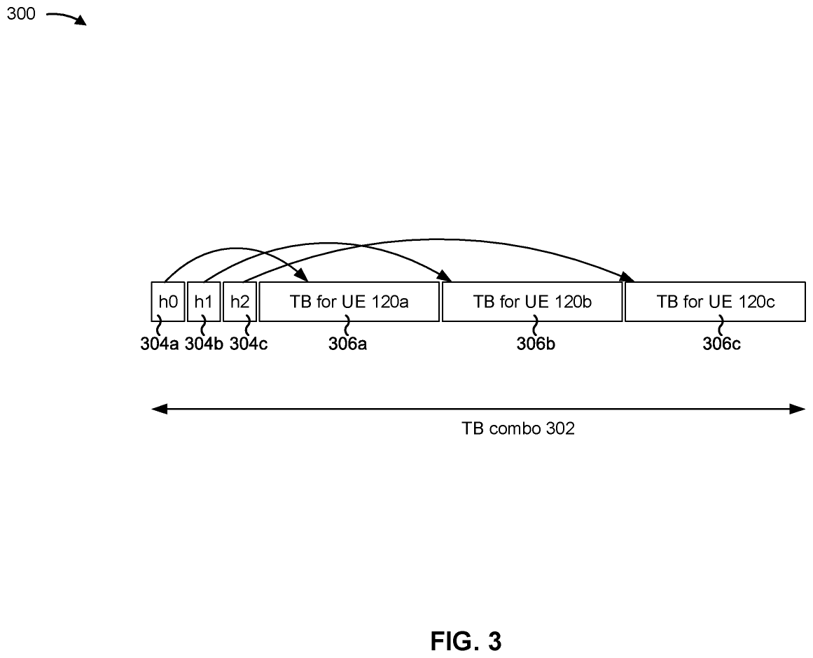

FIG. 3 is a diagram illustrating an example 300 of a multi-user packet (MUP), in accordance with the present disclosure. Some CDMA systems may use MUPs to multiplex data for multiple UEs together. Generally, LTE networks. NR networks, and other similar networks do not use MUPs because those networks are OFDMA systems.

As shown in FIG. 3, an MUP may include a combination traffic block (combo TB) 302. Combo TB 302 may be transmitted from a base station (e.g., base station 110) to a plurality of UEs (e.g., UE 120a, UE 120b, UE 120c, UE 120d. UE 120e, and/or another UE) on a physical downlink shared channel (PDSCH). As shown in FIG. 3, the base station 110 may also include a header (e.g., a physical header) in combo TB 302, where the header includes sub-headers (e.g., h0, h1, and h2 in example 300), where each sub-header is associated with a corresponding UE (e.g., sub-header 304a is associated with UE 120a, sub-header 304b is associated with UE 120b, and sub-header 304c is associated with UE 120c). As used herein, a “physical header” (also called a “preamble”) may refer to information appended to a message by a physical layer (also referred to as a “PHY layer”) before transmission (e.g., over-the-air), such as by the base station 110. Others headers may include information appended to a message by a medium access control (MAC) layer before the message is passed to the PHY layer for transmission, information appended by a radio link control (RLC) layer before the message is passed to the MAC layer, information appended by a packet data convergence protocol (PDCP) layer before the message is passed to the RLC layer, and/or information appended by other layers. Each sub-header may include an identifier (e.g., a UE-ID) associated with the corresponding UE for that sub-header. Additionally, each sub-header may indicate a TB, within the combo TB 302, for the UE corresponding to that sub-header. In example 300, sub-header 304a may indicate a TB 306a that is intended for UE 120a, sub-header 304b may indicate a TB 306b that is intended for UE 120b, and sub-header 304c may indicate a TB 306c that is intended for UE 120c. Accordingly, each UE may determine which sub-header is intended for that UE and, based at least in part on that sub-header, decode a corresponding portion of the combo TB 302 intended for that UE and discard other portions of the combo TB 302.

The base station 110 may schedule transmission of the combo TB 302 to the corresponding UEs using groupcast or broadcast downlink control information (DCI). The DCI may include an identifier associated with the corresponding UEs (e.g., a group radio network temporary identifier (RNTI) and/or another identifier) such that the corresponding UEs may determine that the DCI is intended for those UE and, based at least in part on the DCI, monitor for and receive the PDSCH message that encodes the combo TB 302.

As indicated above, FIG. 3 is provided as an example. Other examples may differ from what is described with respect to FIG. 3.

Some UEs may operate using fewer antennas (e.g., fewer Rx antennas) and/or reduced bandwidth (e.g., operating in a 5-20 MHz range rather than a 100 MHz bandwidth) in order to conserve battery power. Such UEs may include smart devices (such as smart watches, fitness trackers, and/or the like), industrial sensors, video surveillance devices, or other similar devices, and may be referred to as reduced capacity UEs (“RedCap UEs”) and/or “NR-light UEs.” 3GPP Technical Report (TR) 22.832 describes some requirements for some RedCap UEs, such as industrial sensors. For example, TR 22.832 describes industrial sensors as being uplink-intensive with small packet sizes and relatively long transmission intervals (e.g., low data rates). TR 22.832 further describes industrial sensors as needing moderate reliability and latency as well as massive capacity (e.g., up to one RedCap UE per each square meter (m²)).

In order to reduce load on a base station that serves a large number of RedCap UEs, relay devices may be used. As described above in connection with FIG. 1, relay devices may include a relay station and/or another device (e.g., a Wi-Fi router) that communicates with the base station and RedCap UEs in order to facilitate communication between that base station and those RedCap UEs. For example, the relay device may use a Uu interface to communicate with the base station (e.g., on one or more uplink channels and one or more downlink channels) in a wireless network. Additionally, the relay device may use a PC5 interface to communicate with the RedCap UEs (e.g., on one or more sidelink channels).

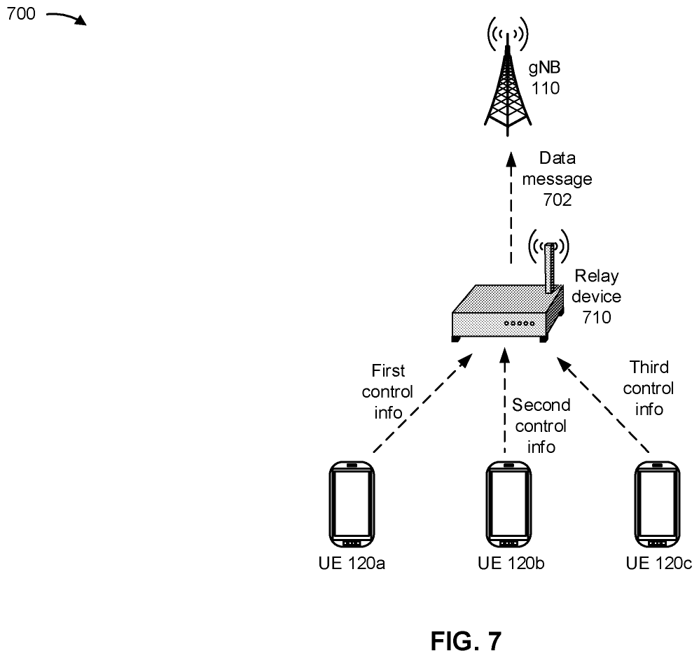

Some techniques and apparatuses described herein enable a relay device (e.g., relay device 410 of FIG. 4) to receive aggregated control information for a plurality of UEs (e.g., RedCap UEs 120a, 120b, and 120c) and distribute the control information to those UEs. As a result, a base station (e.g., base station 110) that serves the UEs may experience reduced network overhead and latency because the base station 110 can aggregate control information for the UEs and instruct the relay device to distribute the control information to each of the UEs. Additionally, some techniques and apparatuses described herein enable a relay device (e.g., relay device 710 of FIG. 7) to receive control information from a plurality of UEs (e.g., RedCap UEs 120a, 120b, and 120c) and aggregate the control information before transmitting to a base station (e.g., base station 110). As a result, the base station 110 that serves the UEs may experience reduced network overhead and improved communication quality because the relay device can transmit a single payload with the aggregated control information using a stronger signal than those signals that the UEs use for transmitting. Some techniques and apparatuses described herein similarly enable a relay device (e.g., relay device 410 of FIG. 4) to receive aggregated data payloads for a plurality of UEs (e.g., RedCap UEs 120a, 120b, and 120c) and distribute the data to those UEs and/or enable a relay device (e.g., relay device 710 of FIG. 7) to receive data payload from a plurality of UEs (e.g., RedCap UEs 120a. 120b, and 120c) and aggregate the data before transmitting to a base station (e.g., base station 110).

FIG. 4 is a diagram illustrating an example 400 associated with transmitting downlink control information in relay-based communication, in accordance with the present disclosure. As shown in FIG. 4, example 400 includes communication between a gNB 110 and a relay device 410. In some aspects, the gNB 110 and the relay device 410 may be included in a wireless network, such as wireless network 100. The gNB 110 and the relay device 410 may communicate via a Uu interface, which may include an uplink and a downlink.

As further shown in FIG. 4, example 400 includes communication between the relay device 410 and one or more UEs (e.g., UE 120a, UE 120b, and UE 120c). Although described below with three UEs, the description similarly applies to fewer UEs (e.g., two UEs) or additional UEs (e.g., four UEs, five UEs, and so on). In some aspects, the relay device 410 and UEs 120a, 120b, and 120c may communicate via a PC5 interface, which may include a sidelink.

In example 400, the gNB 110 may transmit, and the relay device 410 may receive, a data message 402 (e.g., a PDSCH message in example 400) that includes at least first control information associated with a first UE 120a and second control information associated with a second UE 120b. For example, the first control information may include DCI that schedules data for transmission from the gNB 110 to the first UE 120a (e.g., via the relay device 410). Similarly, the second control information may include DCI that schedules data for transmission from the gNB 110 to the second UE 120b (e.g., via the relay device 410). In some aspects, as shown in FIG. 4, the data message may additionally include third control information associated with a third UE 120c. Although described below with first control information, second control information, and third control information, the description similarly applies to control information for fewer UEs (e.g., first control information and second control information only) or control information for additional UEs (e.g., fourth control information, fifth control information, and so on).

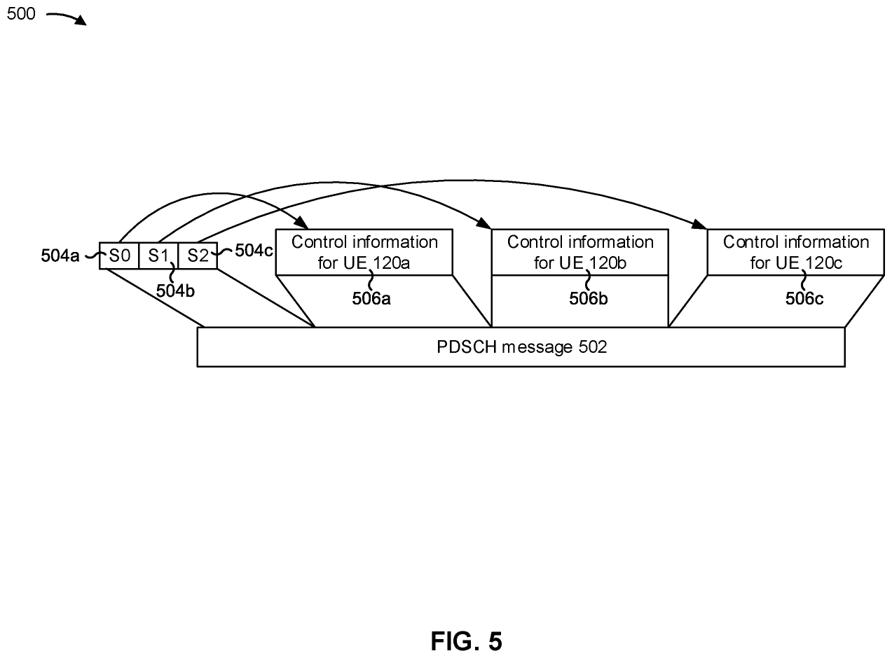

The gNB 110 may aggregate at least the first control information, the second control information, and the third control information into the data message 402. In some aspects, the data message may include a control resource set (CORESET) shared by the first UE 120a, the second UE 120b, and the third UE 120c. For example, the gNB 110 may map the CORESET into the data message 402. The gNB 110 may modulate the first control information, the second control information, and the third control information using quadrature phase key shifting (QPSK) such that the resource elements (REs) used for the CORESET are {−1 −1, −1 1, 1 −1, 1 1}. Accordingly, in some aspects, the data message 402 may include at least one unused RE that is filled with zeroes. The gNB 110 may add a header (e.g., a physical header) to the data message 402. For example, the header may be added as described below in connection with FIG. 5. Accordingly, the header associated with the data message 402 may include at least a first sub-header associated with the first UE 120a, a second sub-header associated with the second UE 120b, and a third sub-header associated with the third UE 120c. Each sub-header may include an identifier associated with a corresponding UE (e.g., a UE-ID); precoding information per RE group (REG), where a REG may include a resource block (RB) that includes 12 REs in a frequency domain (e.g., indicating a set of precoding coefficients used for each REG); a range associated with the CORESET (e.g., indicating how long and/or how many frequencies are included in the CORESET for the corresponding UE); and/or additional information associated with the CORESET.

As an alternative, the gNB 110 may encode content of the first control information with content of the second control information and content of the third control information in the data message 402. For example, the data message 402 may include at least a first control element (e.g., a MAC control element (MAC-CE) and/or another control element) that includes the first control information and a second control element (e.g., a MAC-CE and/or another control element) that includes the second control information. Accordingly, each MAC-CE may include a corresponding header that includes an identifier associated with a corresponding UE (e.g., a cell RNTI (C-RNTI) and/or a UE-ID), an aggregation level (e.g., indicating how many control channel elements (CCEs) are allocated for a control channel, such as a physical downlink control channel (PDCCH), with that corresponding UE), a DCI format (e.g., a format according to which the control information for that corresponding UE is encoded), an allocation associated with the control channel (e.g., the PDCCH) with that corresponding UE, a precoding matrix per REG (e.g., indicating a precoding matrix used for each REG), and/or additional information associated with the control channel and/or the control information for that corresponding UE.

Additionally, or alternatively, the gNB 110 may encode content of the first control information with content of the second control information and content of the third control information into the data message 402. Accordingly, the gNB 110 may encode (e.g., separately) a header (e.g., a physical header) associated with the data message 402. For example, the header may be added as described below in connection with FIG. 5. Accordingly, the header associated with the data message 402 may include at least a first sub-header associated with the first UE 120a, a second sub-header associated with the second UE 120b, and a third sub-header associated with the third UE 120c. Each sub-header may include an identifier associated with a corresponding UE (e.g., a C-RNTI and/or a UE-ID), an aggregation level (e.g., indicating how many CCEs are allocated for a control channel, such as a PDCCH, with that corresponding UE), a DCI format (e.g., a format according to which the control information for that corresponding UE is encoded), an allocation associated with the control channel (e.g., the PDCCH) with that corresponding UE, a precoding matrix per REG (e.g., indicating a precoding matrix used for each REG), and/or additional information associated with the control channel with and/or the control information for that corresponding UE.

In some aspects, the gNB 110 may additionally transmit, and the relay device 410 may receive, control information associated with the relay device 410. For example, the gNB 110 may transmit, and the relay device 410 may receive, a PDCCH message including DCI that schedules the data message 402 for transmission from the gNB 110 to the relay device 410. Accordingly, at least one bit of the control information associated with the relay device 410 may indicate that the data message 402 includes control information associated with a plurality of UEs. For example, the gNB 110 may transmit, and the relay device 410 may receive, a PDCCH message with an additional bit that is set to ‘l’ (or TRUE) when the data message 402 includes control information associated with a plurality of UEs. In another example, at least six bits of a cyclic redundancy check (CRC), associated with the control information that is associated with the relay device 410, may indicate that the data message includes control information associated with a plurality of UEs. In this example, the gNB 110 may add a mask to the last six bits of the CRC to indicate when the data message 402 includes control information associated with a plurality of UEs. Accordingly, the relay device 410 may have two associated RNTIs; one for generating CRCs for general PDCCH messages and another associated with the mask and used to generate CRCs for PDCCH messages associated with data messages that include control information associated with a plurality of UEs (e.g., the data message 402).

Accordingly, the relay device 410 may transmit, and the first UE 120a may receive, the first control information based at least in part on information included in the header associated with the data message 402. Additionally, the relay device 410 may transmit, and the second UE 120b may receive, the second control information based at least in part on the information included in the header. Similarly, the relay device 410 may transmit, and the third UE 120c may receive, the third control information based at least in part on the information included in the header. For example, the relay device 410 may use the CORESET mapped to the data message 402 for transmitting the different control information to the corresponding UEs (e.g., based at least in part on UE identifiers, precoding information, CORESET ranges, and/or additional information included in the header). In another example, the relay device may decode the data message 402 and transmit the different control information to the corresponding UEs based at least in part on UE identifiers, aggregation levels, PDCCH allocations, precoding matrices, and/or additional information included in the header.

In some aspects, the relay device 410 may attempt to decode the data message but fail. Accordingly, the relay device 410 may transmit a NACK signal to the gNB 110. Based at least in part on failure by the relay device 410 to decode the data message, the gNB 110 may transmit a new data message that includes new control information associated with a plurality of UEs. Accordingly, the gNB 110 may decline to retransmit the original data message 402 that failed to decode. As an alternative, the gNB 110 may retransmit the data message to the relay device 410. However, because the reception of the data message 402 is no longer deterministic, the data message may include a control element (e.g. a MAC-CE and/or another control element) that indicates an original transmission time associated with the data message 402 and/or a header (e.g., a physical header and/or another header) that indicates an absolute transmission time associated with the data message 402. Accordingly, the relay device 410 may determine timing for transmitting the different control information to the corresponding UEs based at least in part on the original transmission time or the absolute transmission time.

By using techniques as described in connection with FIG. 4, the relay device 410 can receive aggregated control information for a plurality of UEs (e.g., first UE 120a, second UE 120b, and third UE 120c) and distribute the control information to those UEs. As a result, the gNB 110 that serves the UEs experiences reduced network overhead and latency because the gNB 110 can aggregate control information for the UEs and instruct the relay device 410 to distribute the control information to each of those UEs.

Example 400 may additionally or alternatively be used to aggregate data intended for a plurality of UEs. For example, the gNB 110 may aggregate data payloads into the data message 402 and transmit the data message 402 to the relay device 410. Accordingly, the data message 402 may include a first data payload intended for the first UE 120a, a second data payload intended for the second UE 120b, and a third data payload intended for the third UE 120c. The gNB 110 may aggregate the data payloads similarly to aggregating the control information as described above. Additionally, the relay device 410 may transmit, and the first UE 120a may receive, the first data payload. Additionally, the relay device 410 may transmit, and the second UE 120b may receive, the second data payload. Similarly, the relay device 410 may transmit, and the third UE 120c may receive, the third data payload. The relay device 410 may transmit the data payloads to the corresponding UEs similarly to transmitting the different control information as described above.

As indicated above, FIG. 4 is provided as an example. Other examples may differ from what is described with respect to FIG. 4.

FIG. 5 is a diagram illustrating an example 500 of a data message with aggregated control information, in accordance with the present disclosure. Example 500 may be used in example 400 (e.g., as data message 402) as described above in connection with FIG. 4.

As shown in FIG. 5, a PDSCH message 502 may include first control information 506a associated with a first UE (e.g., UE 120a), second control information 506b associated with a second UE (e.g., UE 120b), and third control information 506c associated with a third UE (e.g., UE 120c). For example, a base station (e.g., base station 110) may map a CORESET shared by the first UE 120a, the second UE 120b, and the third UE 120c into the PDSCH message 502. As an alternative, the base station 110 may encode content of the first control information with content of the second control information and content of the third control information in the data message 402. Although described below with first control information, second control information, and third control information, the description similarly applies to control information for fewer UEs (e.g., first control information and second control information only) or control information for additional UEs (e.g., fourth control information, fifth control information, and so on).

As further shown in FIG. 5, the base station 110 may also encode a header (e.g., a physical header) associated with the PDSCH message 502. The base station 110 may encode the header separately. In some aspects, the header may include sub-headers (e.g., S0, S1, and S2 in example 500), where each sub-header is associated with a corresponding UE (e.g., sub-header 504a is associated with UE 120a, sub-header 504b is associated with UE 120b, and sub-header 504c is associated with UE 120c). Each sub-header may include an identifier (e.g., a UE-ID) associated with the corresponding UE for that sub-header. Accordingly, a relay device (e.g., relay device 410) may use the sub-headers to transmit corresponding control information included in the PDSCH message 502 to a corresponding UE.

As indicated above, FIG. 5 is provided as an example. Other examples may differ from what is described with respect to FIG. 5.

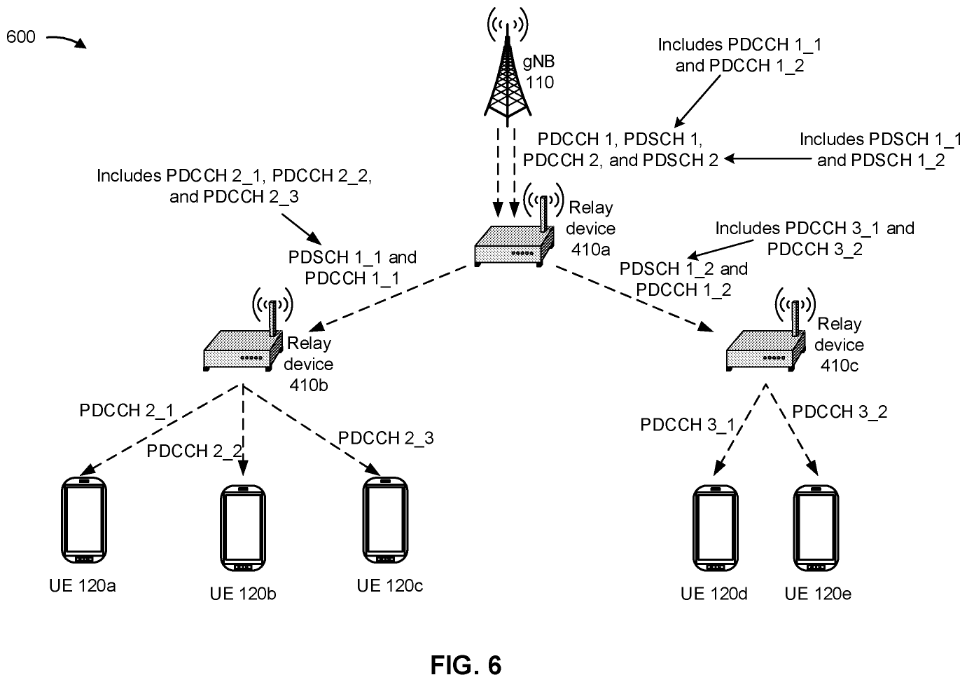

FIG. 6 is a diagram illustrating an example 600 associated with transmitting downlink control information in relay-based communication, in accordance with the present disclosure. As shown in FIG. 6, example 600 includes communication between a gNB 110 and a first relay device 410a. In some aspects, the gNB 110 and the first relay device 410a may be included in a wireless network, such as wireless network 100. The gNB 110 and the first relay device 410s may communicate via a Uu interface, which may include an uplink and a downlink.

As further shown in FIG. 6, example 600 includes communication between the first relay device 410a and two additional relay devices (e.g., second relay device 410b and third relay device 410c). In some aspects, the first relay device 410a, the second relay device 410b, and the third relay device 410c may communicate via a PC5 interface, which may include a sidelink. Although described below with two additional relay devices, the description similarly applies to additional relay devices (e.g., three relay devices, four relay devices, and so on).

As further shown in FIG. 6, example 600 includes communication between the second relay device 410b and one or more UEs (e.g., UE 120a, UE 120b, and UE 120c). Although described below with three UEs, the description similarly applies to fewer UEs (e.g., two UEs) or additional UEs (e.g., four UEs, five UEs, and so on). In some aspects, the second relay device 410b and UEs 120a, 120b, and 120c may communicate via a PC5 interface, which may include a sidelink. Example 600 further includes communication between the third relay device 410c and one or more UEs (e.g., UE 120d and UE 120e). Although described below with two UEs, the description similarly applies to additional UEs (e.g., three UEs, four UEs, and so on). In some aspects, the third relay device 410c and UEs 120d and 120e may communicate via a PC5 interface, which may include a sidelink.

In example 600, the gNB 110 may transmit, and the first relay device 410a may receive, first control information associated with the first relay device 410a. For example, the gNB 110 may transmit, and the first relay device 410a may receive, a PDCCH message (PDCCH 1 in example 600) including DCI that schedules a first data message (PDSCH 1 in example 600) for transmission from the gNB 110 to the first relay device 410a. The first data message may include at least first control information associated with the second relay device 410b and second control information associated with the third relay device 410c. For example, the gNB 110 may map a CORESET, shared by the second relay device 410b and the third relay device 410c, into PDSCH 1, or may encode content of the first control information with content of the second control information in PDSCH 1. Accordingly, at least one bit of PDCCH 1 may indicate that the PDSCH 1 includes control information associated with a plurality of relay devices.

Similarly, the gNB 110 may transmit, and the first relay device 410a may receive, second control information associated with the first relay device 410a. For example, the gNB 110 may transmit, and the first relay device 410a may receive, a PDCCH message (PDCCH 2 in example 600) including DCI that schedules a second data message (PDSCH 2 in example 600) for transmission from the gNB 110 to the first relay device 410a. The second data message may include at least first control information associated with the UE 120a, second control information associated with the UE 120b, third control information associated with the UE 120c, fourth control information associated with the UE 120d, and fifth control information associated with the UE 120e. For example, the gNB 110 may map a CORESET, shared by the UE 120a, the UE 120b, the UE 120c, the UE 120d, and the UE 120e, into PDSCH 2, or may encode content of the first control information with content of the second control information, the third control information, the fourth control information, and the fifth control information in PDSCH 2. Accordingly, at least one bit of PDCCH 2 may indicate that the PDSCH 2 includes control information associated with a plurality of UEs.

As further shown in FIG. 6, the first relay device 410a may transmit, and the second relay device 410b may receive, control information associated with the second relay device 410b. For example, the first relay device 410a may transmit, and the second relay device 410b may receive, a PDCCH message (PDCCH 1_1 in example 600) including DCI that schedules a data message (PDSCH 1_1 in example 600) for transmission from the first relay device 410a to the second relay device 410b. The first relay device 410a may transmit PDCCH 1_1 to the second relay device 410b based at least in part on a header associated with PDSCH 1 from the gNB 110. Additionally, the first relay device 410a may transmit PDSCH 1_1 to the second relay device 410b based at least in part on a header associated with PDSCH 2 from the gNB 110. The data message may include at least first control information associated with the UE 120a, second control information associated with the UE 120b, and third control information associated with the UE 120c. For example, the first relay device 410a may map a CORESET, shared by the UE 120a, the UE 120b, and the UE 120c, into PDSCH 1_1, or may encode content of the first control information with content of the second control information and the third control information in PDSCH 1_1. Accordingly, at least one bit of PDCCH 1_1 may indicate that the PDSCH 1_1 includes control information associated with a plurality of UEs. The second relay device 410b may thus transmit corresponding control information to the UEs. In example 600, the second relay device 410b transmits, and the UE 120a receives, the first control information. Similarly, the second relay device 410b transmits, and the UE 120b receives, the second control information. Similarly, the second relay device 410b transmits, and the UE 120c receives, the third control information.

Similarly, the first relay device 410a may transmit, and the third relay device 410c may receive, control information associated with the third relay device 410c. For example, the first relay device 410a may transmit, and the third relay device 410c may receive, a PDCCH message (PDCCH 1_2 in example 600) including DCI that schedules a data message (PDSCH 1_2 in example 600) for transmission from the first relay device 410a to the third relay device 410c. The first relay device 410a may transmit PDCCH 1_2 to the third relay device 410c based at least in part on a header associated with PDSCH 1 from the gNB 110. Additionally, the first relay device 410a may transmit PDSCH 1_2 to the third relay device 410c based at least in part on a header associated with PDSCH 2 from the gNB 110. The data message may include at least fourth control information associated with the UE 120d and fifth control information associated with the UE 120e. For example, the first relay device 410a may map a CORESET, shared by the UE 120d and the UE 120e, into PDSCH 1_2, or may encode content of the fourth control information with content of the fifth control information in PDSCH 1_2. Accordingly, at least one bit of PDCCH 1_2 may indicate that the PDSCH 1_2 includes control information associated with a plurality of UEs. The third relay device 410c may thus transmit corresponding control information to the UEs. In example 600, the third relay device 410c transmits, and the UE 120d receives, the fourth control information. Similarly, the third relay device 410c transmits, and the UE 120e receives, the fifth control information.

By using techniques as described in connection with FIG. 6, the first relay device 410a can receive aggregated control information for a plurality of UEs (e.g., first UE 120a, second UE 120b, third UE 120c, fourth UE 120d, and fifth UE 120e) and distribute the control information to different relay devices (e.g., second relay device 410b and third relay device 410c), which distribute the control information to those UEs. As a result, the gNB 110 that serves the UEs experiences reduced network overhead and latency because the gNB 110 can aggregate control information for the UEs and use the relay devices 410a, 410b, and 410c to distribute the control information to each of those UEs.

Example 600 may additionally or alternatively be used to aggregate data intended for a plurality of UEs. For example, the gNB 110 may aggregate data payloads into PDSCH 2 and transmit PDSCH 2 to the first relay device 410a. Accordingly, PDSCH 2 may include a first data payload intended for the first UE 120a, a second data payload intended for the second UE 120b, a third data payload intended for the third UE 120c, a fourth data payload intended for the fourth UE 120d, and a fifth data payload intended for the fifth UE 120e. The gNB 110 may aggregate the data payloads similarly to aggregating the control information as described above. Additionally, the first relay device 410a may transmit PDSCH 1_1 (which includes the first data payload, the second data payload, and third data payload) to the second relay device 410b, such that the second relay device 410b may transmit, and the first UE 120a may receive, the first data payload. Additionally, the second relay device 410b may transmit, and the second UE 120b may receive, the second data payload, and the second relay device 410b may transmit, and the third UE 120c may receive, the third data payload. The second relay device 410b may transmit the data payloads to the corresponding UEs similarly to transmitting the different control information as described above. Similarly, the third relay device 410c may transmit PDSCH 1_2 (which includes the fourth data payload and the fifth data payload) to the third relay device 410c, such that the third relay device 410c may transmit, and the fourth UE 120d may receive, the fourth data payload. Additionally, the third relay device 410c may transmit, and the fifth UE 120e may receive, the fifth data payload. The third relay device 410c may transmit the data payloads to the corresponding UEs similarly to transmitting the different control information as described above.

As indicated above, FIG. 6 is provided as an example. Other examples may differ from what is described with respect to FIG. 6.

FIG. 7 is a diagram illustrating an example 700 associated with transmitting uplink control information in relay-based communication, in accordance with the present disclosure. As shown in FIG. 7, example 700 includes communication between a gNB 110 and a relay device 710. In some aspects, the gNB 110 and the relay device 710 may be included in a wireless network, such as wireless network 100. The gNB 110 and the relay device 710 may communicate via a Uu interface, which may include an uplink and a downlink.

As further shown in FIG. 7, example 700 includes communication between the relay device 710 and one or more UEs (e.g., UE 120a, UE 120b, and UE 120c). Although described below with three UEs, the description similarly applies to fewer UEs (e.g., two UEs) or additional UEs (e.g., four UEs, five UEs, and so on). In some aspects, the relay device 410 and UEs 120a, 120b, and 120c may communicate via a PC5 interface, which may include a sidelink.

In example 700, the first UE 120a may transmit, and the relay device 710 may receive, first control information. For example, the first control information may include uplink control information (UCI) that includes hybrid automatic repeat request (HARQ) feedback (e.g., an acknowledgment (ACK) signal or a NACK signal), a scheduling request (SR), and/or channel state information (CSI) for transmission from the first UE 120a to the gNB 110 (e.g., via the relay device 710). Additionally, the second UE 120b may transmit, and the relay device 710 may receive, second control information. The second control information may similarly include UCI that includes HARQ feedback, an SR, and/or CSI for transmission from the second UE 120b to the gNB 110 (e.g., via the relay device 710). In some aspects, as shown in FIG. 7, the third UE 120c may transmit, and the relay device 710 may additionally receive, third control information. Although described below with first control information, second control information, and third control information, the description similarly applies to control information from fewer UEs (e.g., first control information and second control information only) or control information from additional UEs (e.g., fourth control information, fifth control information, and so on).

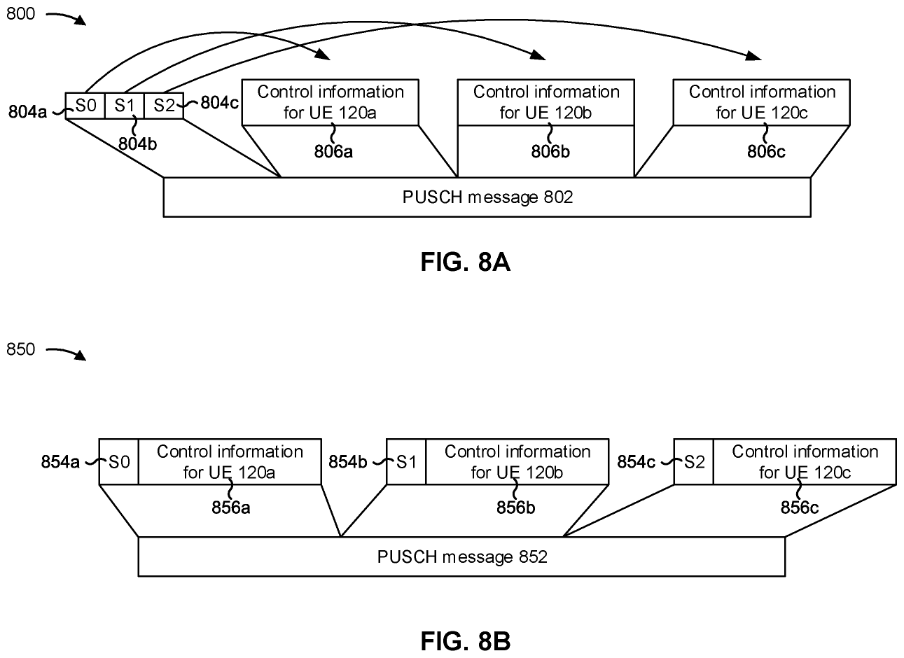

The relay device 710 may aggregate at least the first control information and the second control information into a data message 702 (e.g., a physical uplink shared channel (PUSCH) message in example 700) that includes at least the first control information, the second control information, and the third control information. In some aspects, the data message 702 may be associated with a group UCI that identifies the first control information, the second control information, and the third control information piggybacked over a data channel (e.g., a PUSCH between the relay device 710 and the gNB 110). For example, the group UCI may be added as described below in connection with FIG. 8A. Accordingly, the group UCI may include identifiers associated with the corresponding UEs (e.g., UE-IDs), ranges of the data channel (e.g., the PUSCH) associated with the different control information, and/or additional information associated with the different control information. As an alternative, the data message may include at least a first header (e.g., a physical header) associated with the first control information, a second header (e.g., a physical header) associated with the second control information, and a third header (e.g., a physical header) associated with the third control information. For example, the headers may be added as described below in connection with FIG. 8B. Accordingly, each header may include an identifier associated with the corresponding UE (e.g., a UE-ID), a range of the data channel (e.g., the PUSCH) associated with the control information for that corresponding UE, and/or additional information associated with the control information for that corresponding UE.

Accordingly, the relay device 710 may transmit, and the gNB 110 may receive, the data message 702 that includes at least the first control information, the second control information, and the third control information. The gNB 110 may use the group UCI and/or the headers to decode different control information associated with the corresponding UEs (e.g., based at least in part on UE identifiers, PUSCH ranges, and/or additional information included in the group UCI and/or the headers).

In some aspects, the gNB 110 may attempt to decode the data message but fail. Accordingly, the gNB 110 may transmit a NACK signal to the relay device 710. Accordingly, based at least in part on failure by the gNB 110 to decode the data message, the relay device 710 may retransmit the data message 702.

By using techniques as described in connection with FIG. 7, the relay device 710 may receive control information from a plurality of UEs (e.g., UEs 120a, 120b, and 120c) and aggregate the control information before transmitting to the gNB 110. As a result, the gNB 110 that serves the UEs may experience reduced network overhead and improved communication quality because the relay device 710 can transmit a single payload with the aggregated control information using a stronger signal than those signals that the UEs use for transmitting.

Example 700 may additionally or alternatively be used to aggregate data from a plurality of UEs. For example, the relay device 710 may receive data payloads from the UEs 120a, 120b, and 120c, and aggregate those data payloads into the data message 702. The relay device 710 may aggregate the data payloads similarly to aggregating the control information as described above. Additionally, the relay device 710 may transmit, and the gNB 110 may receive, the data message 702. The gNB 110 may decode the data payloads to the corresponding UEs similarly to decoding the different control information as described above.

As indicated above, FIG. 7 is provided as an example. Other examples may differ from what is described with respect to FIG. 7.

FIGS. 8A and 8B are diagrams illustrating examples 800 and 850, respectively, of a data message with aggregated control information, in accordance with the present disclosure. Example 800 and/or example 850 may be used in example 700 (e.g., as data message 702) as described above in connection with FIG. 7.

As shown in FIG. 8A, a PUSCH message 802 may include first control information 806a from a first UE (e.g., UE 120a), second control information 806b from a second UE (e.g., UE 120b), and third control information 806c from a third UE (e.g., UE 120c). For example, a relay device (e.g., relay device 710) may piggyback the first control information, the second control information, and the third control information onto a PUSCH as PUSCH message 802. As further shown in FIG. 8A, the relay device 710 may also encode a group UCI associated with the PUSCH message 802. The relay device 710 may encode the group UCI separately. For example, the group UCI may be generated using polar codes while the control information is piggybacked onto the PUSCH using low-density parity-check (LDPC) codes. In some aspects, the group UCI may include different information (e.g., S0, S1, and S2 in example 800) associated with a corresponding UE (e.g., information 804a is associated with UE 120a, information 804b is associated with UE 120b, and information 804c is associated with UE 120c). Thus, the group UCI may include identifiers (e.g., UE-IDs) associated with the corresponding UEs. Accordingly, a base station (e.g., base station 110) may use the group UCI to identify corresponding control information included in the PUSCH message 802 for the UEs.

As shown in FIG. 8B, a PUSCH message 852 may include first control information 856a from a first UE (e.g., UE 120a), second control information 856b from a second UE (e.g., UE 120b), and third control information 856c from a third UE (e.g., UE 120c). As further shown in FIG. 8B, the relay device 710 may add a corresponding header (e.g., a physical header) to each of the first control information, the second control information, and the third control information. In some aspects, the relay device 710 may generate the headers using LDPC codes. In some aspects, each header (e.g., S0, S1, and S2 in example 850) may include different information associated with a corresponding UE (e.g., header 854a is associated with UE 120a, header 854b is associated with UE 120b, and header 854c is associated with UE 120c). Thus, each header may include an identifier (e.g., a UE-ID) associated with the corresponding UE. Accordingly, a base station (e.g., base station 110) may use the headers to identify corresponding control information included in the PUSCH message 852 for the UEs.

Although described above with first control information, second control information, and third control information, the description similarly applies to control information for fewer UEs (e.g., first control information and second control information only) or control information for additional UEs (e.g., fourth control information, fifth control information, and so on).

As indicated above, FIG. 8 is provided as an example. Other examples may differ from what is described with respect to FIG. 8.

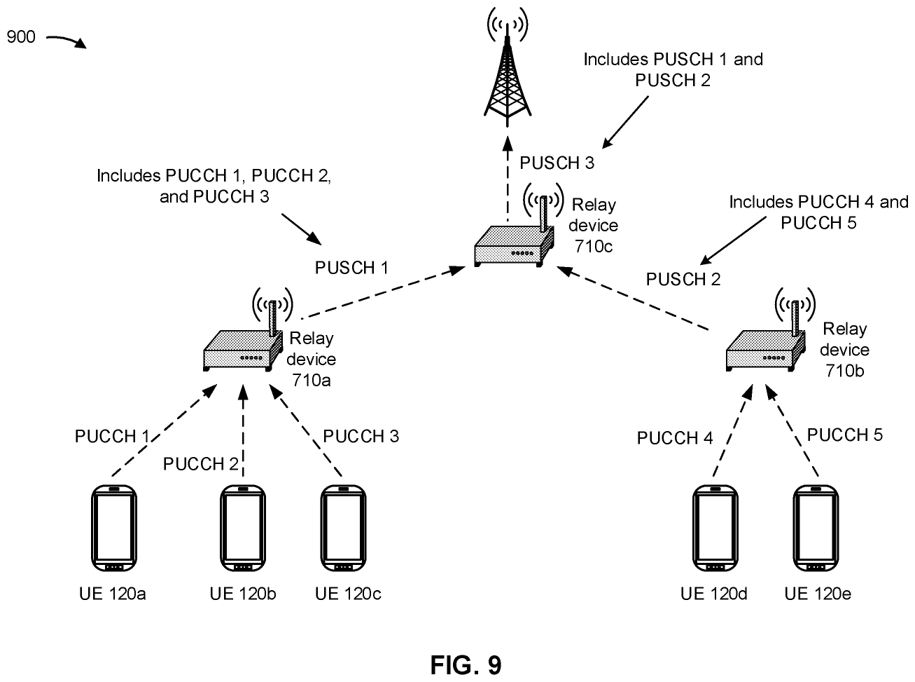

FIG. 9 is a diagram illustrating an example 900 associated with transmitting uplink control information in relay-based communication, in accordance with the present disclosure. As shown in FIG. 9, example 900 includes communication between a first relay device 710a and one or more UEs (e.g., UE 120a, UE 120b, and UE 120c). Although described below with three UEs, the description similarly applies to fewer UEs (e.g., two UEs) or additional UEs (e.g., four UEs, five UEs, and so on). In some aspects, the first relay device 710a and UEs 120a, 120b, and 120c may communicate via a PC5 interface, which may include a sidelink.

Example 900 further includes communication between a second relay device 710b and one or more UEs (e.g., UE 120d and UE 120c). Although described below with two UEs, the description similarly applies to additional UEs (e.g., three UEs, four UEs, and so on). In some aspects, the second relay device 710b and UEs 120d and 120e may communicate via a PC5 interface, which may include a sidelink. Although described below with two relay devices, the description similarly applies to additional relay devices (e.g., three relay devices, four relay devices, and so on).

As further shown in FIG. 9, example 900 includes communication between the first relay device 710a, the second relay device 710b, and an additional relay device (e.g., third relay device 710c). In some aspects, the first relay device 710a, the second relay device 710b, and the third relay device 710c may communicate via a PC5 interface, which may include a sidelink.

As further shown in FIG. 9, example 900 includes communication between a gNB 110 and the third relay device 710c. In some aspects, the gNB 110 and the third relay device 710c may be included in a wireless network, such as wireless network 100. The gNB 110 and the third relay device 710c may communicate via a Uu interface, which may include an uplink and a downlink.

In example 900, the UE 120a transmits, and the first relay device 710a receives, first control information associated with the UE 120a. Similarly, the UE 120b transmits, and the first relay device 710a receives, second control information associated with the UE 120b. Similarly, the UE 120c transmits, and the first relay device 710a receives, third control information associated with the UE 120c. Accordingly, the first relay device 710a may transmit, and the third relay device 710c may receive, a data message including the first control information, the second control information, and the third control information. For example, the first relay device 710a may transmit, and the third relay device 710c may receive, a PUSCH message (PUSCH 1 in example 900) that includes the first control information, the second control information, and the third control information. For example, the first relay device 710a may encode a group UCI and/or headers into PUSCH 1 that identify the first control information, the second control information, and the third control information.

Similarly, the UE 120d transmits, and the second relay device 710b receives, fourth control information associated with the UE 120d. Additionally, the UE 120e transmits, and the second relay device 710b receives, fifth control information associated with the UE 120e. Accordingly, the second relay device 710b may transmit, and the third relay device 710c may receive, a data message including the fourth control information and the fifth control information. For example, the second relay device 710b may transmit, and the third relay device 710c may receive, a PUSCH message (PUSCH 2 in example 900) that includes the fourth control information and the fifth control information. For example, the second relay device 710b may encode a group UCI and/or headers into PUSCH 2 that identify the fourth control information and the fifth control information.

As further shown in FIG. 9, the third relay device 710c may transmit, and the gNB 110 may receive, a data message (PUSCH 3 in example 900) that includes at least first control information associated with the UE 120a, second control information associated with the UE 120b, third control information associated with the UE 120c, fourth control information associated with the UE 120d, and fifth control information associated with the UE 120e. For example, the third relay device 710c may encode a group UCI and/or headers into PUSCH 2 that identify the first control information, the second control information, the third control information, the fourth control information, and the fifth control information. The gNB 110 may thus decode corresponding control information from the UEs.

By using techniques as described in connection with FIG. 9, the first relay device 710a can aggregate control information from a plurality of UEs (e.g., first UE 120a, second UE 120b, and third UE 120c), and the second relay device 710b can aggregate control information from another plurality of UEs (e.g., fourth UE 120d and fifth UE 120c). Additionally, the third relay device 710c can aggregate control information from different relay devices (e.g., first relay device 710a and second relay device 710b) and transmit the aggregated control information to the gNB 110. As a result, the gNB 110 that serves the UEs experiences reduced network overhead and improved communication quality because the third relay device 710c can transmit a single payload with the aggregated control information using a stronger signal than those signals that the UEs use for transmitting.

Example 900 may additionally or alternatively be used to aggregate data from a plurality of UEs. For example, the first relay device 710a may aggregate data payloads into PUSCH 1 and transmit PUSCH 1 to the third relay device 710c. Accordingly, PUSCH 1 may include a first data payload from the first UE 120a, a second data payload from the second UE 120b, and a third data payload from the third UE 120c. Similarly, the second relay device 710b may aggregate data payloads into PUSCH 2 and transmit PUSCH 2 to the third relay device 710c. Accordingly, PUSCH 2 may include a fourth data payload from the fourth UE 120d and a fifth data payload from the fifth UE 120e. The first relay device 710a and the second relay device 710b may aggregate the data payloads similarly to aggregating the control information as described above. Additionally, the third relay device 710c may transmit PUSCH 3 (which includes the first data payload, the second data payload, third data payload, the fourth data payload, and the fifth data payload) to the gNB 110, such that the gNB 110 can decode the different data payloads. The third relay device 410c may aggregate the data payloads from the corresponding UEs similarly to aggregating the control information as described above.

As indicated above, FIG. 9 is provided as an example. Other examples may differ from what is described with respect to FIG. 9.

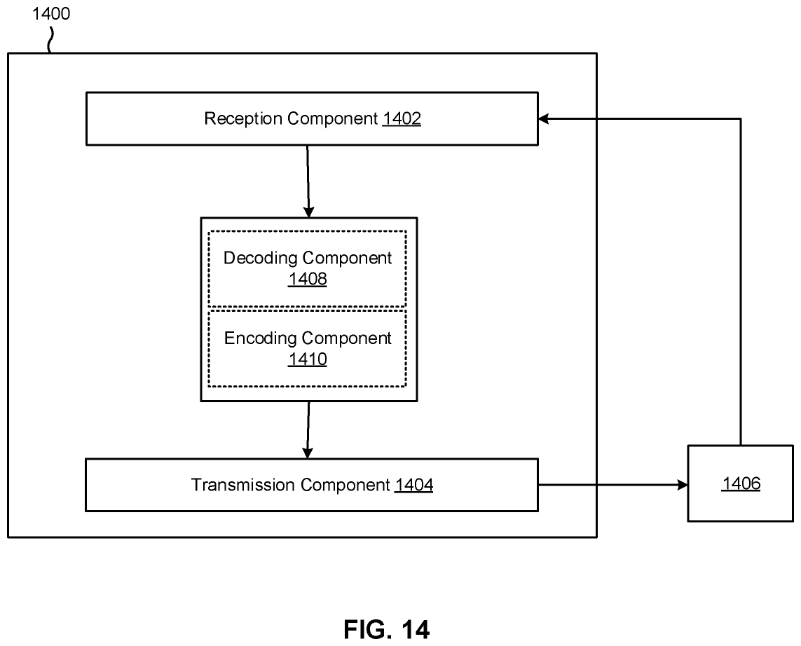

FIG. 10 is a diagram illustrating an example process 1000 performed, for example, by a relay device, in accordance with the present disclosure. Example process 1000 is an example where the relay device (e.g., relay device 410 and/or apparatus 1400 of FIG. 14) performs operations associated with control information transmission in relay-based communication.

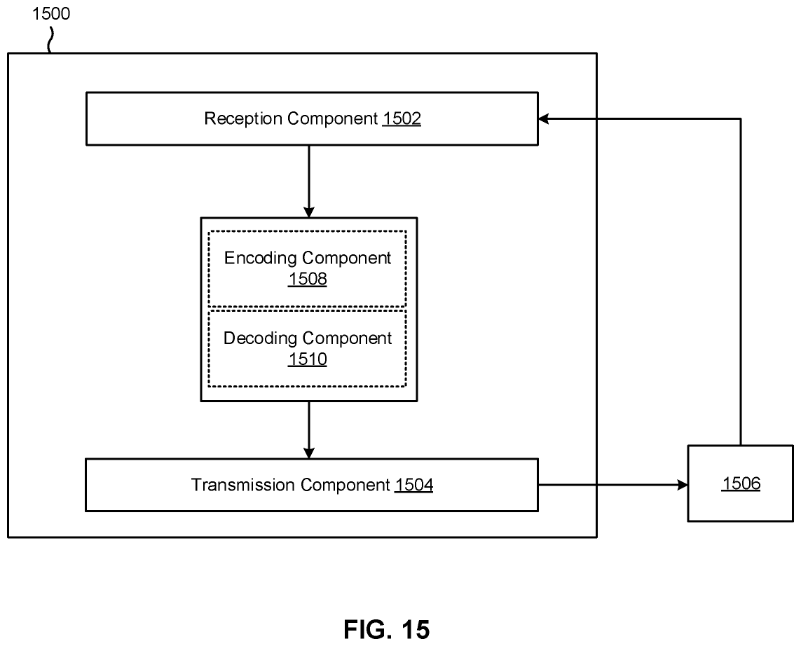

As shown in FIG. 10, in some aspects, process 1000 may include receiving, from a base station (e.g., base station 110 and/or apparatus 1500 of FIG. 15), a data message that includes at least first control information associated with a first UE (e.g., first UE 120a) and second control information associated with a second UE (e.g., second UE 120b) (block 1010). For example, the relay device (e.g., using reception component 1402, depicted in FIG. 14) may receive the data message that includes at least the first control information associated with the first UE and the second control information associated with the second UE, as described above.

As further shown in FIG. 10, in some aspects, process 1000 may include transmitting, to the first UE, the first control information based at least in part on information included in a header associated with the data message (block 1020). For example, the relay device (e.g., using transmission component 1404, depicted in FIG. 14) may transmit, to the first UE, the first control information, as described above.

As further shown in FIG. 10, in some aspects, process 1000 may include transmitting, to the second UE, the second control information based at least in part on the information included in the header (block 1030). For example, the relay device (e.g., using transmission component 1404) may transmit, to the second UE, the second control information, as described above.

Process 1000 may include additional aspects, such as any single aspect or any combination of aspects described below and/or in connection with one or more other processes described elsewhere herein.

In a first aspect, process 1000 further includes receiving (e.g., using reception component 1402), from the base station, control information associated with the relay device.

In a second aspect, alone or in combination with the first aspect, at least one bit of the control information associated with the relay device indicates that the data message includes control information associated with a plurality of UEs.

In a third aspect, alone or in combination with one or more of the first and second aspects, at least six bits of a CRC, associated with the control information that is associated with the relay device, indicate that the data message includes control information associated with a plurality of UEs.

In a fourth aspect, alone or in combination with one or more of the first through third aspects, the data message includes a CORESET shared by the first UE and the second UE.

In a fifth aspect, alone or in combination with one or more of the first through fourth aspects, the data message includes at least one unused RE that is filled with zeroes.

In a sixth aspect, alone or in combination with one or more of the first through fifth aspects, the header includes at least a first sub-header associated with the first UE and a second sub-header associated with the second UE.

In a seventh aspect, alone or in combination with one or more of the first through sixth aspects, the data message encodes content of the first control information with content of the second control information.

In an eighth aspect, alone or in combination with one or more of the first through seventh aspects, the data message includes at least a first control element that includes the first control information and a second control element that includes the second control information.

In a ninth aspect, alone or in combination with one or more of the first through eighth aspects, the header is separately encoded from the data message.

In a tenth aspect, alone or in combination with one or more of the first through ninth aspects, process 1000 further includes attempting to decode (e.g., using decoding component 1408, depicted in FIG. 14) a previous data message that includes control information associated with a plurality of UEs, where the data message that includes the first control information and the second control information is received based at least in part on failure by the relay device to decode the previous data message.

In an eleventh aspect, alone or in combination with one or more of the first through tenth aspects, the data message includes a control element that indicates an original transmission time associated with the data message.

In a twelfth aspect, alone or in combination with one or more of the first through eleventh aspects, the data message includes a header that indicates an absolute transmission time associated with the data message.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a base station, in accordance with the present disclosure. Example process 1100 is an example where the base station (e.g., base station 110 and/or apparatus 1500 of FIG. 15) performs operations associated with control information transmission in relay-based communication.

As shown in FIG. 11, in some aspects, process 1100 may include aggregating, into a data message, at least first control information associated with a first UE (e.g., UE 120a) and second control information associated with a second UE (e.g., UE 120b) (block 1110). For example, the base station (e.g., using encoding component 1508, depicted in FIG. 15) may aggregate, into the data message, at least the first control information associated with the first UE and the second control information associated with the second UE, as described above.

As further shown in FIG. 11, in some aspects, process 1100 may include transmitting, to a relay device (e.g., relay device 410 and/or apparatus 1400 of FIG. 14), the data message that includes at least the first control information and the second control information (block 1120). For example, the base station (e.g., using transmission component 1504, depicted in FIG. 15) may transmit the data message that includes at least the first control information and the second control information, as described above.

Process 1100 may include additional aspects, such as any single aspect or any combination of aspects described below and/or in connection with one or more other processes described elsewhere herein.

In a first aspect, process 1100 further includes transmitting (e.g., using transmission component 1504), to the relay device, control information associated with the relay device.

In a second aspect, alone or in combination with the first aspect, at least one bit of the control information associated with the relay device indicates that the data message includes control information associated with a plurality of UEs.

In a third aspect, alone or in combination with one or more of the first and second aspects, at least six bits of a CRC, associated with the control information that is associated with the relay device, indicate that the data message includes control information associated with a plurality of UEs.

In a fourth aspect, alone or in combination with one or more of the first through third aspects, the data message includes a CORESET shared by the first UE and the second UE.

In a fifth aspect, alone or in combination with one or more of the first through fourth aspects, the data message is associated with a physical header that includes at least a first sub-header associated with the first UE and a second sub-header associated with the second UE.

In a sixth aspect, alone or in combination with one or more of the first through fifth aspects, the data message encodes content of the first control information with content of the second control information.

In a seventh aspect, alone or in combination with one or more of the first through sixth aspects, the data message includes at least a first control element that includes the first control information and a second control element that includes the second control information.

In an eighth aspect, alone or in combination with one or more of the first through seventh aspects, the data message is associated with a physical header that is separately encoded from the data message.

In a ninth aspect, alone or in combination with one or more of the first through eighth aspects, process 1100 further includes receiving (e.g., using reception component 1502, depicted in FIG. 15), from the relay device, a NACK signal associated with a previous data message that includes control information associated with a plurality of UEs, where the data message that includes the first control information and the second control information is transmitted based at least in part on receiving the NACK signal.

In a tenth aspect, alone or in combination with one or more of the first through ninth aspects, the data message includes a control element that indicates an original transmission time associated with the data message.

In an eleventh aspect, alone or in combination with one or more of the first through tenth aspects, the data message includes a header that indicates an absolute transmission time associated with the data message.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a relay device, in accordance with the present disclosure. Example process 1200 is an example where the relay device (e.g., relay device 710 and/or apparatus 1400 of FIG. 14) performs operations associated with control information transmission in relay-based communication.

As shown in FIG. 12, in some aspects, process 1200 may include receiving, from a first UE (e.g., UE 120a), first control information (block 1210). For example, the relay device (e.g., using reception component 1402, depicted in FIG. 14) may receive the first control information, as described above.

As further shown in FIG. 12, in some aspects, process 1200 may include receiving, from a second UE (e.g., UE 120b), second control information (block 1220). For example, the relay device (e.g., using reception component 1402) may receive the second control information, as described above.

As further shown in FIG. 12, in some aspects, process 1200 may include aggregating the first control information and the second control information into a data message that includes at least the first control information and the second control information (block 1230). For example, the relay device (e.g., using encoding component 1410, depicted in FIG. 14) may aggregate the first control information and the second control information into the data message, as described above.

As further shown in FIG. 12, in some aspects, process 1200 may include transmitting, to a base station (e.g., base station 110 and/or apparatus 1500 of FIG. 15), the data message that includes at least the first control information and the second control information (block 1240). For example, the relay device (e.g., using transmission component 1404, depicted in FIG. 14) may transmit the data message that includes at least the first control information and the second control information, as described above.

Process 1200 may include additional aspects, such as any single aspect or any combination of aspects described below and/or in connection with one or more other processes described elsewhere herein.

In a first aspect, the data message is associated with a group UCI that identifies the first control information and the second control information piggybacked over a data channel.

In a second aspect, alone or in combination with the first aspect, the data message includes at least a first header associated with the first control information and a second header associated with the second control information.

In a third aspect, alone or in combination with one or more of the first and second aspects, process 1200 further includes receiving (e.g., using reception component 1402), from the base station, a NACK signal, and retransmitting (e.g., using transmission component 1404) the data message to the base station based at least in part on receiving the NACK signal.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a relay device, in accordance with the present disclosure. Example process 1300 is an example where the relay device (e.g., relay device 410 and/or apparatus 1400 of FIG. 14) performs operations associated with control information transmission in relay-based communication for reduced capacity user equipment.

As shown in FIG. 13, in some aspects, process 1300 may include receiving, from a base station (e.g., base station 110 and/or apparatus 1500 of FIG. 15), a data message that includes at least first data associated with a first UE (e.g., UE 120a) and second data associated with a second UE (block 1310). For example, the relay device (e.g., using reception component 1402, depicted in FIG. 14) may receive the data message that includes at least the first data associated with the first UE and the second data associated with the second UE, as described above.

As further shown in FIG. 13, in some aspects, process 1300 may include transmitting, to the first UE, the first data based at least in part on information included in a header associated with the data message (block 1320). For example, the relay device (e.g., using transmission component 1404, depicted in FIG. 14) may transmit the first data, as described above.

As further shown in FIG. 13, in some aspects, process 1300 may include transmitting, to the second UE, the second data based at least in part on the information included in the header (block 1330). For example, the relay device (e.g., using transmission component 1404) may transmit the second data, as described above.

Process 1300 may include additional aspects, such as any single aspect or any combination of aspects described below and/or in connection with one or more other processes described elsewhere herein. Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a block diagram of an example apparatus 1400 for wireless communication. The apparatus 1400 may be a relay device, or a relay device may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include one or more of a decoding component 1408 or an encoding component 1410, among other examples.

In some aspects, the apparatus 1400 may be configured to perform one or more operations described herein in connection with FIGS. 4-9. Additionally, or alternatively, the apparatus 1400 may be configured to perform one or more processes described herein, such as process 1000 of FIG. 10, process 1100 of FIG. 11, process 1200 of FIG. 12, or a combination thereof. In some aspects, the apparatus 1400 and/or one or more components shown in FIG. 14 may include one or more components of the UE described above in connection with FIG. 2. Additionally, or alternatively, one or more components shown in FIG. 14 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1406. In some aspects, the reception component 1402 may include one or more antennas, a demodulator, a MIMO detector, a receive processor, a controller/processor, a memory, or a combination thereof, of the UE described above in connection with FIG. 2.

The transmission component 1404 may transmit communications, such as reference signals, control information, data communications, or a combination thereof, to the apparatus 1406. In some aspects, one or more other components of the apparatus 1406 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modulator, a transmit MIMO processor, a transmit processor, a controller/processor, a memory, or a combination thereof, of the UE described above in connection with FIG. 2. In some aspects, the transmission component 1404 may be co-located with the reception component 1402 in a transceiver.

In some aspects, the reception component 1402 may receive, from the apparatus 1406, a data message that includes at least first control information associated with a first UE and second control information associated with a second UE. Accordingly, the transmission component 1404 may transmit, to the first UE, the first control information based at least in part on information included in a header associated with the data message. The transmission component 1404 may transmit, to the second UE, the second control information based at least in part on the information included in the header. In some aspects, the reception component 1402 may additionally receive, from the apparatus 1406, control information associated with the apparatus 1400.

In some aspects, the decoding component 1408 may attempt to decode a previous data message that includes control information associated with a plurality of UEs. In some aspects, the decoding component 1408 may include one or more antennas, a demodulator, a MIMO detector, a receive processor, a controller/processor, a memory, or a combination thereof, of the UE described above in connection with FIG. 2. Accordingly, the reception component 1402 may receive the data message that includes the first control information and the second control information based at least in part on failure by the decoding component 1408 to decode the previous data message. The transmission component 1404 may transmit a NACK signal to the apparatus 1406 based at least in part on failure by the decoding component 1408 to decode the previous data message.

In some aspects, the reception component 1402 may receive, from a first UE, first control information, and may receive, from a second UE, second control information. The encoding component 1410 may aggregate the first control information and the second control information into a data message that includes at least the first control information and the second control information. In some aspects, the encoding component 1410 may include one or more antennas, a modulator, a transmit MIMO processor, a transmit processor, a controller/processor, a memory, or a combination thereof, of the UE described above in connection with FIG. 2. Accordingly, the transmission component 1404 may transmit, to the apparatus 1406, the data message that includes at least the first control information and the second control information.

In some aspects, the reception component 1402 may receive, from the apparatus 1406, a NACK signal. Accordingly, the transmission component 1404 may retransmit the data message to the apparatus 1406 based at least in part on the reception component 1402 receiving the NACK signal.

In some aspects, the reception component 1402 may receive, from the apparatus 1406, a data message that includes at least first data associated with a first UE and second data associated with a second UE. Accordingly, the transmission component 1404 may transmit, to the first UE, the first data based at least in part on information included in a header associated with the data message. Additionally, the transmission component 1404 may transmit, to the second UE, the second data based at least in part on the information included in the header.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a block diagram of an example apparatus 1500 for wireless communication. The apparatus 1500 may be a base station, or a base station may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include one or more of an encoding component 1508 or a decoding component 1510, among other examples.

In some aspects, the apparatus 1500 may be configured to perform one or more operations described herein in connection with FIGS. 4-9. Additionally, or alternatively, the apparatus 1500 may be configured to perform one or more processes described herein, such as process 1100 of FIG. 11, or a combination thereof. In some aspects, the apparatus 1500 and/or one or more components shown in FIG. 15 may include one or more components of the base station described above in connection with FIG. 2. Additionally, or alternatively, one or more components shown in FIG. 15 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1506. In some aspects, the reception component 1502 may include one or more antennas, a demodulator, a MIMO detector, a receive processor, a controller/processor, a memory, or a combination thereof, of the base station described above in connection with FIG. 2.

The transmission component 1504 may transmit communications, such as reference signals, control information, data communications, or a combination thereof, to the apparatus 1506. In some aspects, one or more other components of the apparatus 1506 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modulator, a transmit MIMO processor, a transmit processor, a controller/processor, a memory, or a combination thereof, of the base station described above in connection with FIG. 2. In some aspects, the transmission component 1504 may be co-located with the reception component 1502 in a transceiver.

In some aspects, the encoding component 1508 may aggregate, into a data message, at least first control information associated with a first UE and second control information associated with a second UE. In some aspects, the encoding component 1508 may include one or more antennas, a modulator, a transmit MIMO processor, a transmit processor, a controller/processor, a memory, or a combination thereof, of the base station described above in connection with FIG. 2. Accordingly, the transmission component 1504 may transmit, to the apparatus 1506, the data message that includes at least the first control information and the second control information. In some aspects, the transmission component 1504 may additionally transmit, to the apparatus 1506, control information associated with the apparatus 1506.

In some aspects, the reception component 1502 may receive, from the apparatus 1506, a NACK signal associated with a previous data message that includes control information associated with a plurality of UEs. Accordingly, the transmission component 1504 may transmit the data message that includes the first control information and the second control information based at least in part on the reception component 1502 receiving the NACK signal.

In some aspects, the reception component 1502 may receive, from the apparatus 1506, a data message that includes at least first control information from a first UE and second control information from a second UE. Accordingly, the decoding component 1510 may decode the first control information based at least in part on information included in a group UCI and/or a header associated with the data message, and may decode the second control information based at least in part on the information included in the group UCI and/or the header. In some aspects, the decoding component 1510 may include one or more antennas, a demodulator, a MIMO detector, a receive processor, a controller/processor, a memory, or a combination thereof, of the base station described above in connection with FIG. 2.

In some aspects, the decoding component 1510 may attempt to decode the data message. Accordingly, the reception component 1502 may receive a retransmission of the data message that includes the first control information and the second control information based at least in part on failure by the decoding component 1510 to decode an initial transmission of the data message. The transmission component 1504 may transmit a NACK signal to the apparatus 1506 based at least in part on failure by the decoding component 1510 to decode the initial transmission of data message.

In some aspects, the reception component 1502 may receive, from apparatus 1506, a data message that includes at least first data from a first UE and second data from a second UE. The transmission component 1504 may transmit, to the first UE, the first data based at least in part on information included in a header associated with the data message. The transmission component 1504 may transmit, to the second UE, the second data based at least in part on the information included in the header. Accordingly, the decoding component 1510 may decode the first data based at least in part on information included in a group UCI and/or a header associated with the data message, and may decode the second data based at least in part on the information included in the group UCI and/or the header.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some aspects of the present disclosure:

Aspect 1: A method of wireless communication performed by a relay device, comprising: receiving, from a base station, a data message that includes at least first control information associated with a first user equipment (UE) and second control information associated with a second UE; transmitting, to the first UE, the first control information based at least in part on information included in a header associated with the data message; and transmitting, to the second UE, the second control information based at least in part on the information included in the header.

Aspect 2: The method of aspect 1, further comprising: receiving, from the base station, control information associated with the relay device.

Aspect 3: The method of any of aspects 1 through 2, at least one bit of the control information associated with the relay device indicates that the data message includes control information associated with a plurality of UEs.

Aspect 4: The method of any of aspects 1 through 3, at least six bits of a cyclic redundancy check (CRC), associated with the control information that is associated with the relay device, indicate that the data message includes control information associated with a plurality of UEs.

Aspect 5: The method of any of aspects 1 through 4, wherein the data message includes a control resource set (CORESET) shared by the first UE and the second UE.

Aspect 6: The method of aspect 5, wherein the data message includes at least one unused resource element (RE) that is filled with zeroes.

Aspect 7: The method of any of aspects 1 through 4, wherein the data message encodes content of the first control information with content of the second control information.

Aspect 8: The method of aspect 7, wherein the data message includes at least a first control element that includes the first control information and a second control element that includes the second control information.

Aspect 9: The method of any of aspects 1 through 8, wherein the header is separately encoded from the data message.

Aspect 10: The method of any of aspects 1 through 9, wherein the header includes at least a first sub-header associated with the first UE and a second sub-header associated with the second UE.

Aspect 11: The method of any of aspects 1 through 10, further comprising: attempting to decode a previous data message that includes control information associated with a plurality of UEs, wherein the data message that includes the first control information and the second control information is received based at least in part on failure by the relay device to decode the previous data message.

Aspect 12 The method of aspect 11, wherein the data message includes a control element that indicates an original transmission time associated with the data message.

Aspect 13: The method of aspect 11, wherein the data message includes a header that indicates an absolute transmission time associated with the data message.

Aspect 14: A method of wireless communication performed by a base station, comprising: aggregating, into a data message, at least first control information associated with a first user equipment (UE) and second control information associated with a second UE; and transmitting, to a relay device, the data message that includes at least the first control information and the second control information.

Aspect 15: The method of aspect 14, further comprising: transmitting, to the relay device, control information associated with the relay device.

Aspect 16: The method of any of aspects 14 through 15, at least one bit of the control information associated with the relay device indicates that the data message includes control information associated with a plurality of UEs.

Aspect 17: The method of any of aspects 14 through 16, at least six bits of a cyclic redundancy check (CRC), associated with the control information that is associated with the relay device, indicate that the data message includes control information associated with a plurality of UEs.

Aspect 18: The method of any of aspects 14 through 17, wherein the data message includes a control resource set (CORESET) shared by the first UE and the second UE.

Aspect 19: The method of any of aspects 14 through 17, wherein the data message encodes content of the first control information with content of the second control information.

Aspect 20: The method of aspect 19, wherein the data message includes at least a first control element that includes the first control information and a second control element that includes the second control information.

Aspect 21: The method of any of aspects 14 through 20, wherein the data message is associated with a physical header that is separately encoded from the data message.

Aspect 22: The method of any of aspects 14 through 21, wherein the data message is associated with a physical header that includes at least a first sub-header associated with the first UE and a second sub-header associated with the second UE.

Aspect 23: The method of any of aspects 14 through 22, further comprising: receiving, from the relay device, a negative-acknowledgment (NACK) signal associated with a previous data message that includes control information associated with a plurality of UEs, wherein the data message that includes the first control information and the second control information is transmitted based at least in part on receiving the NACK signal.

Aspect 24: The method of aspect 23, wherein the data message includes a control element that indicates an original transmission time associated with the data message.

Aspect 25: The method of aspect 23, wherein the data message includes a header that indicates an absolute transmission time associated with the data message.

Aspect 26: A method of wireless communication performed by a relay device, comprising: receiving, from a first user equipment (UE), first control information; receiving, from a second UE, second control information; aggregating the first control information and the second control information into a data message that includes at least the first control information and the second control information; and transmitting, to a base station, the data message that includes at least the first control information and the second control information.

Aspect 27: The method of aspect 26, wherein the data message is associated with a group uplink control information (UCI) that identifies the first control information and the second control information piggybacked over a data channel.

Aspect 28: The method of aspect 26, wherein the data message includes at least a first header associated with the first control information and a second header associated with the second control information.

Aspect 29: The method of any of aspects 26 through 28, further comprising: receiving, from the base station, a negative-acknowledgment (NACK) signal; and retransmitting the data message to the base station based at least in part on receiving the NACK signal.

Aspect 30: A method of wireless communication performed by a relay device, comprising: receiving, from a base station, a data message that includes at least first data associated with a first user equipment (UE) and second data associated with a second UE; transmitting, to the first UE, the first data based at least in part on information included in a header associated with the data message; and transmitting, to the second UE, the second data based at least in part on the information included in the header.

Aspect 31: An apparatus for wireless communication at a device, comprising a processor; memory coupled with the processor; and instructions stored in the memory and executable by the processor to cause the apparatus to perform the method of one or more aspects of aspects 1-13.

Aspect 32: A device for wireless communication, comprising a memory and one or more processors coupled to the memory, the memory and the one or more processors configured to perform the method of one or more aspects of aspects 1-13.

Aspect 33: An apparatus for wireless communication, comprising at least one means for performing the method of one or more aspects of aspects 1-13.

Aspect 34: A non-transitory computer-readable medium storing code for wireless communication, the code comprising instructions executable by a processor to perform the method of one or more aspects of aspects 1-13.

Aspect 35: A non-transitory computer-readable medium storing a set of instructions for wireless communication, the set of instructions comprising one or more instructions that, when executed by one or more processors of a device, cause the device to perform the method of one or more aspects of aspects 1-13.

Aspect 36: An apparatus for wireless communication at a device, comprising a processor; memory coupled with the processor; and instructions stored in the memory and executable by the processor to cause the apparatus to perform the method of one or more aspects of aspects 14-25.

Aspect 37: A device for wireless communication, comprising a memory and one or more processors coupled to the memory, the memory and the one or more processors configured to perform the method of one or more aspects of aspects 14-25.

Aspect 38: An apparatus for wireless communication, comprising at least one means for performing the method of one or more aspects of aspects 14-25.

Aspect 39: A non-transitory computer-readable medium storing code for wireless communication, the code comprising instructions executable by a processor to perform the method of one or more aspects of aspects 14-25.

Aspect 40: A non-transitory computer-readable medium storing a set of instructions for wireless communication, the set of instructions comprising one or more instructions that, when executed by one or more processors of a device, cause the device to perform the method of one or more aspects of aspects 14-25.

Aspect 41: An apparatus for wireless communication at a device, comprising a processor; memory coupled with the processor; and instructions stored in the memory and executable by the processor to cause the apparatus to perform the method of one or more aspects of aspects 26-29.

Aspect 42: A device for wireless communication, comprising a memory and one or more processors coupled to the memory, the memory and the one or more processors configured to perform the method of one or more aspects of aspects 26-29.

Aspect 43: An apparatus for wireless communication, comprising at least one means for performing the method of one or more aspects of aspects 26-29.

Aspect 44: A non-transitory computer-readable medium storing code for wireless communication, the code comprising instructions executable by a processor to perform the method of one or more aspects of aspects 26-29.

Aspect 45: A non-transitory computer-readable medium storing a set of instructions for wireless communication, the set of instructions comprising one or more instructions that, when executed by one or more processors of a device, cause the device to perform the method of one or more aspects of aspects 26-29.

Aspect 46: An apparatus for wireless communication at a device, comprising a processor; memory coupled with the processor; and instructions stored in the memory and executable by the processor to cause the apparatus to perform the method of aspect 30.

Aspect 47: A device for wireless communication, comprising a memory and one or more processors coupled to the memory, the memory and the one or more processors configured to perform the method of aspect 30.

Aspect 48: An apparatus for wireless communication, comprising at least one means for performing the method of aspect 30.

Aspect 49: A non-transitory computer-readable medium storing code for wireless communication, the code comprising instructions executable by a processor to perform the method of aspect 30.

Aspect 50: A non-transitory computer-readable medium storing a set of instructions for wireless communication, the set of instructions comprising one or more instructions that, when executed by one or more processors of a device, cause the device to perform the method of aspect 30.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A relay device for wireless communication, comprising:
a memory; and
one or more processors operatively coupled to the memory, the memory and the one or more processors configured to:
receive, from a base station, a data message that includes at least first control information associated with a first user equipment (UE) and second control information associated with a second UE;
transmit, to the first UE, the first control information based at least in part on information included in a header associated with the data message; and
transmit, to the second UE, the second control information based at least in part on the information included in the header.

2. The relay device of claim 1, wherein the memory and the one or more processors are further configured to:
receive, from the base station, control information associated with the relay device.

3. The relay device of claim 2, wherein at least one bit of the control information associated with the relay device indicates that the data message includes control information associated with a plurality of UEs.

4. The relay device of claim 2, wherein at least six bits of a cyclic redundancy check (CRC), associated with the control information that is associated with the relay device, indicate that the data message includes control information associated with a plurality of UEs.

5. The relay device of claim 1, wherein the data message includes a control resource set (CORESET) shared by the first UE and the second UE.

6. The relay device of claim 5, wherein the data message includes at least one unused resource element (RE) that is filled with zeroes.

7. The relay device of claim 5, wherein the header includes at least a first sub-header associated with the first UE and a second sub-header associated with the second UE.

8. The relay device of claim 1, wherein the data message encodes content of the first control information with content of the second control information.

9. The relay device of claim 8, wherein the data message includes at least a first control element that includes the first control information and a second control element that includes the second control information.

10. The relay device of claim 8, wherein the header is separately encoded from the data message.

11. The relay device of claim 1, wherein the memory and the one or more processors are further configured to:
attempt to decode a previous data message that includes control information associated with a plurality of UEs,
wherein the data message that includes the first control information and the second control information is received based at least in part on failure by the relay device to decode the previous data message.

12. The relay device of claim 1, wherein the data message includes a control element that indicates an original transmission time associated with the data message.

13. The relay device of claim 1, wherein the data message includes a header that indicates an absolute transmission time associated with the data message.

14. A base station for wireless communication, comprising:
a memory; and
one or more processors operatively coupled to the memory, the memory and the one or more processors configured to:
aggregate, into a data message, at least first control information associated with a first user equipment (UE) and second control information associated with a second UE; and
transmit, to a relay device, the data message that includes at least the first control information and the second control information.

15. The base station of claim 14, wherein the memory and the one or more processors are further configured to:
transmit, to the relay device, control information associated with the relay device.

16. The base station of claim 15, wherein at least one bit of the control information associated with the relay device indicates that the data message includes control information associated with a plurality of UEs.

17. The base station of claim 15, wherein at least six bits of a cyclic redundancy check (CRC), associated with the control information that is associated with the relay device, indicate that the data message includes control information associated with a plurality of UEs.

18. The base station of claim 14, wherein the data message includes a control resource set (CORESET) shared by the first UE and the second UE.

19. The base station of claim 18, wherein the data message is associated with a physical header that includes at least a first sub-header associated with the first UE and a second sub-header associated with the second UE.

20. The base station of claim 14, wherein the data message encodes content of the first control information with content of the second control information.

21. The base station of claim 20, wherein the data message includes at least a first control element that includes the first control information and a second control element that includes the second control information.

22. The base station of claim 20, wherein the data message is associated with a physical header that is separately encoded from the data message.

23. The base station of claim 14, wherein the memory and the one or more processors are further configured to:
receive, from the relay device, a negative-acknowledgment (NACK) signal associated with a previous data message that includes control information associated with a plurality of UEs,
wherein the data message that includes the first control information and the second control information is transmitted based at least in part on receiving the NACK signal.

24. The base station of claim 14, wherein the data message includes a control element that indicates an original transmission time associated with the data message.

25. The base station of claim 14, wherein the data message includes a header that indicates an absolute transmission time associated with the data message.

26. A relay device for wireless communication, comprising:
a memory; and
one or more processors operatively coupled to the memory, the memory and the one or more processors configured to:
receive, from a first user equipment (UE), first control information;
receive, from a second UE, second control information;
aggregate the first control information and the second control information into a data message that includes at least the first control information and the second control information, and
transmit, to a base station, the data message that includes at least the first control information and the second control information.

27. The relay device of claim 26, wherein the data message is associated with a group uplink control information (UCI) that identifies the first control information and the second control information piggybacked over a data channel.

28. The relay device of claim 26, wherein the data message includes at least a first header associated with the first control information and a second header associated with the second control information.

29. The relay device of claim 26, wherein the memory and the one or more processors are further configured to:
receive, from the base station, a negative-acknowledgment (NACK) signal; and
retransmit the data message to the base station based at least in part on receiving the NACK signal.

30. A relay device for wireless communication, comprising:
a memory; and
one or more processors operatively coupled to the memory, the memory and the one or more processors configured to:
receive, from a base station, a data message that includes at least first data associated with a first user equipment (UE) and second data associated with a second UE;
transmit, to the first UE, the first data based at least in part on information included in a header associated with the data message; and
transmit, to the second UE, the second data based at least in part on the information included in the header.
